(19) United States
(12) Patent Application Publication
(10) Pub. No.: US 2013/0091150 A1
(43) Pub. Date: Apr. 11, 2013

(54) DETERMIINING SIMILARITY BETWEEN ELEMENTS OF AN ELECTRONIC DOCUMENT

(71) Applicants: Jian-Ming Jin, Beijing (CN); Suk Hwan Lim, Mountain View, CA (US); Li-Wei Zheng, Beijing (CN); Jian Fan, San Jose, CA (US); Eamonn O'Brien-Strain, San Francisco, CA (US); Yuhong Xiong, Mountain View, CA (US); Jerry J. Liu, Sunnyvale, CA (US)

(72) Inventors: Jian-Ming Jin, Beijing (CN); Suk Hwan Lim, Mountain View, CA (US); Li-Wei Zheng, Beijing (CN); Jian Fan, San Jose, CA (US); Eamonn O'Brien-Strain, San Francisco, CA (US); Yuhong Xiong, Mountain View, CA (US); Jerry J. Liu, Sunnyvale, CA (US)

(21) Appl. No.: 13/805,212

(22) PCT Filed: Jun. 30, 2010
(86) PCT No.: PCT/CN2010/074813

§ 371 Date: Dec. 18, 2012

(51) Int. Cl. G06F 17/30

(52) U.S. Cl. CPC G06F 17/3053
USPC 707/749

(57) ABSTRACT

Disclosed is a computer-implemented method of determining smarty between first and second elements of an electronic document. The method uses a computer to calculate a plurality of measures of similarity between the first and second elements in at least two representations of the electronic document. A computer program product and system implementing this method are also disclosed.

### BACKGROUND

Automated information retrieval from electronic documents, such as web pages, is desirable. Many automated solutions use the structure of the target electronic document to retrieve such data. For instance, search algorithms using the document object model (DOM) tree representation of a web page are known.

The principle of creating a DOM tree representation for a web page is known. The following definitions are used in the context of DOM trees. A root node is a node that may have children but does not have a parent. Thus, it is the top node in a DOM tree. A child node is a node that has a parent node. It may also have children of its own. A leaf node is a child node with a parent but no children of its own. It is a bottom node in a DOM tree.

Typically, information of interest to a user will reside in blocks or areas in an electronic document that are homogenous in property, such as a leaf node for example. These elements of an electronic document are also referred to as “atoms”, and are known as “web atoms” (WAs) if the electronic document is a web page.

### BRIEF DESCRIPTION OF THE EMBODIMENTS

Embodiments of the invention are described in more detail and by way of non-limiting examples with reference to the accompanying drawings, wherein

FIG. 1 depicts a measure of similarity based on the Euclidean distance D_{E} between the geometric locations of the two atoms, A1 and A2, in a visual representation of a web page;

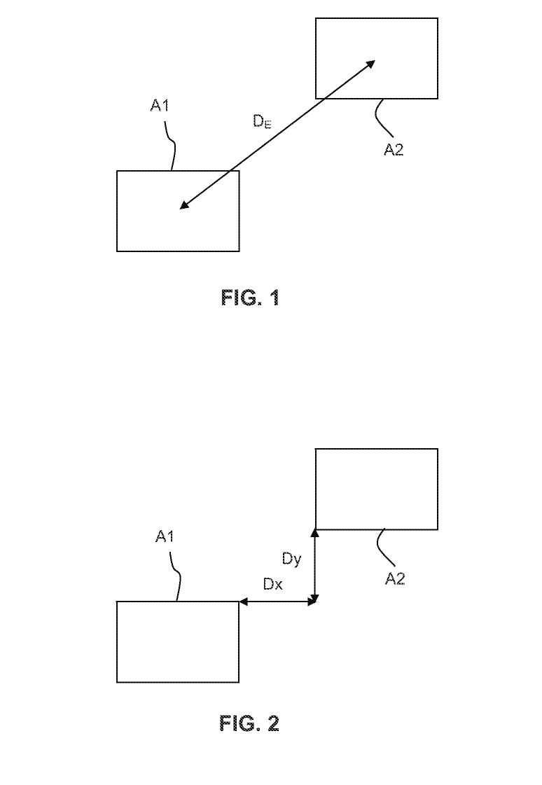

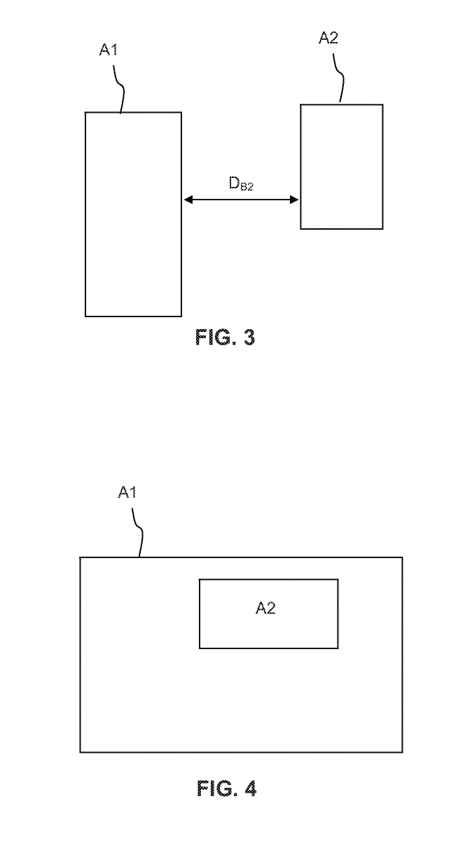

FIGS. 2 and 3 depict measures of similarity based on the block distance between first A1 and second A2 atoms in a visual representation of the web page;

FIG. 4 depicts a measure of similarity based on whether two atoms have geometric enclosure;

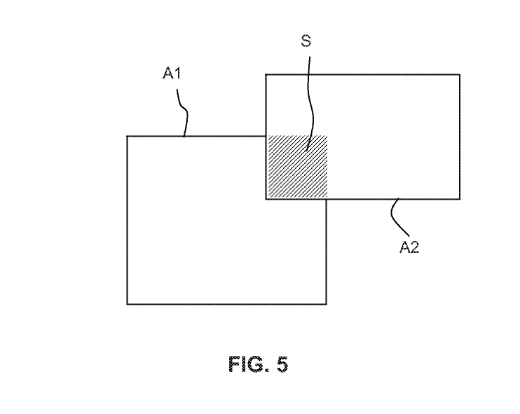

FIG. 5 depicts a measure of similarity based on whether two atoms intersect each other in a visual representation of the web page;

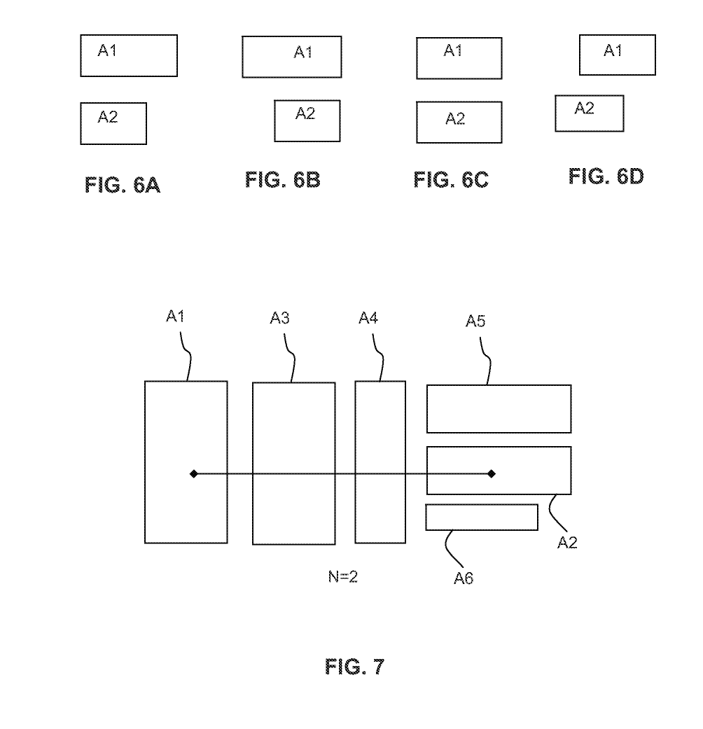

FIGS. 6A to 6D depict examples of alignment of two atoms which can be used as a measure of similarity of the atoms;

FIG. 7 depicts a measure of similarity between first and second atoms based on how many other atoms are situated between the atoms in a visual representation of the web page;

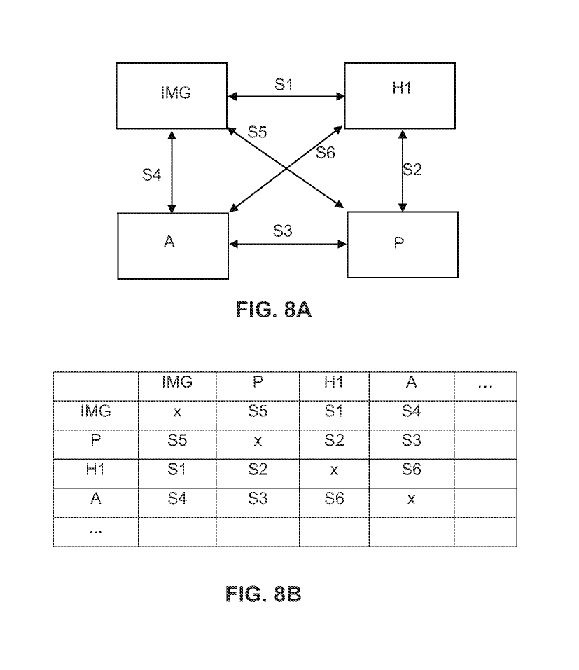

FIG. 8 a measure of similarity based on HTML tags attached to atoms, wherein similarity values between different HTML tags are defined in a table;

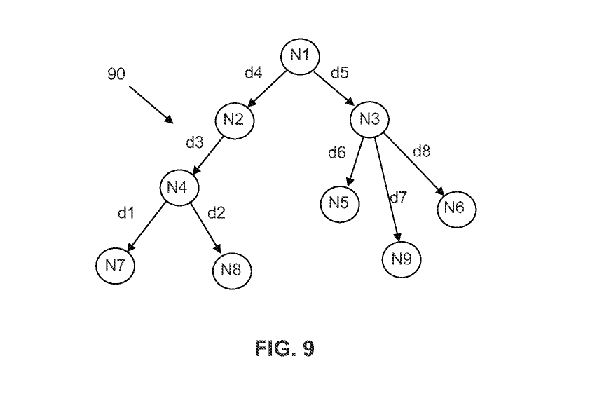

FIG. 9 depicts a DOM tree of an example web page;

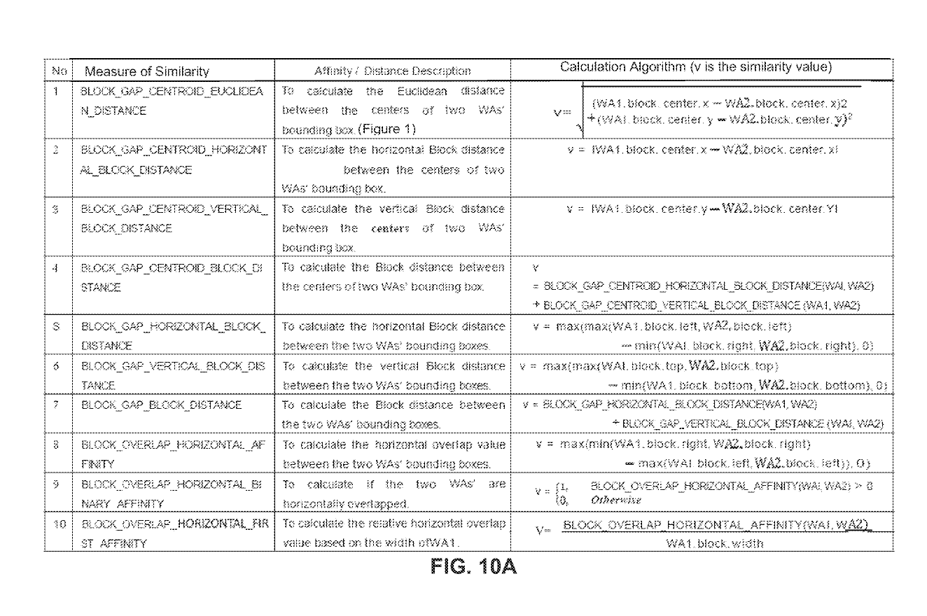

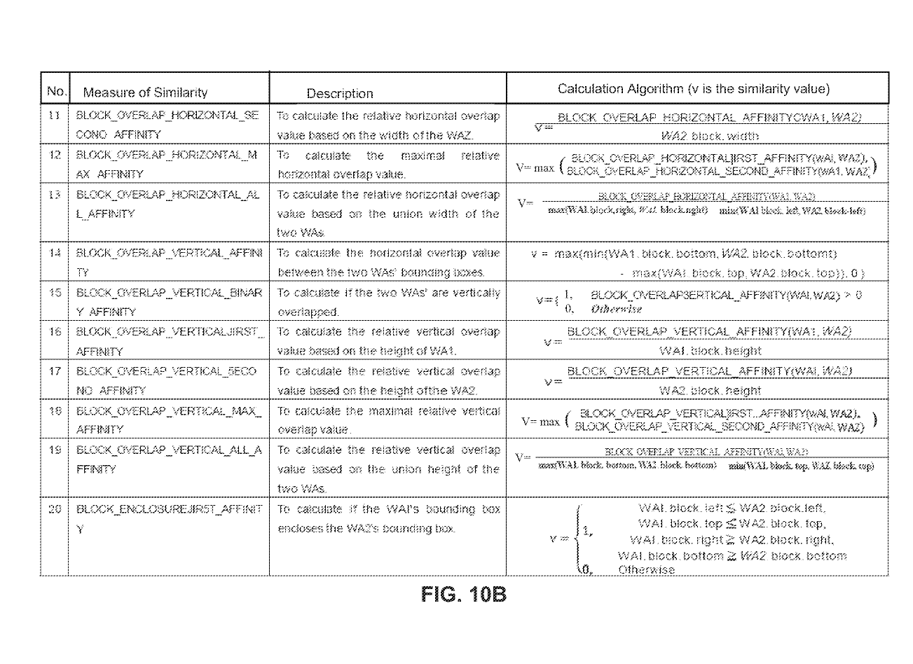

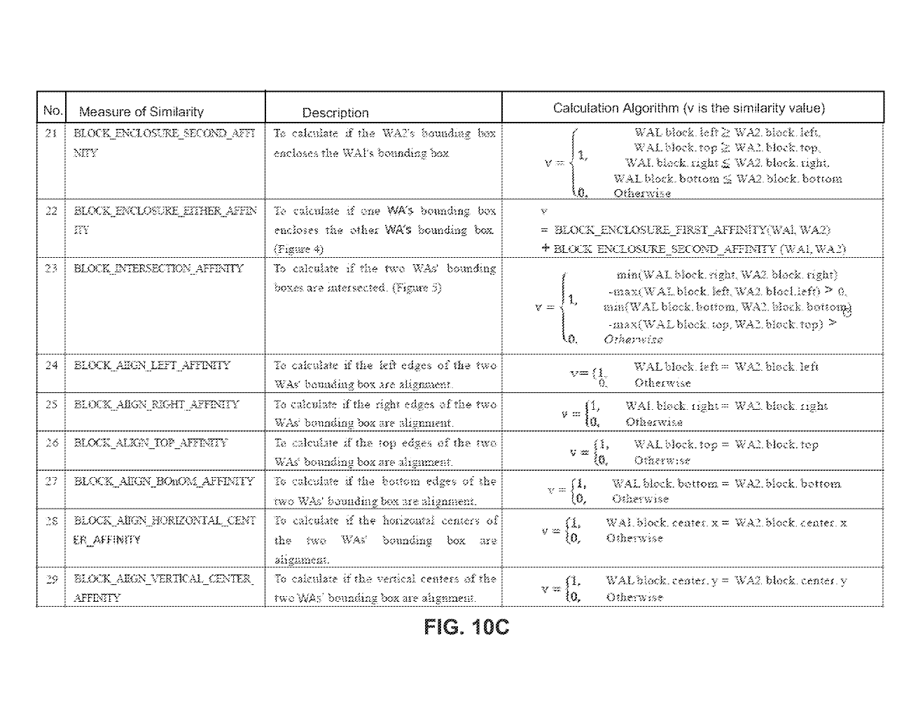

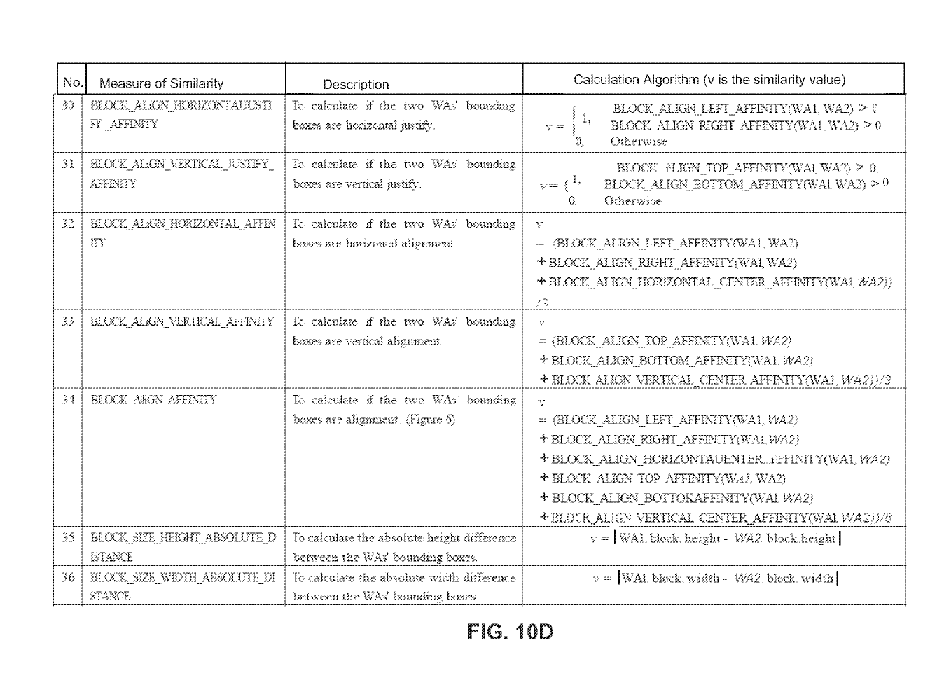

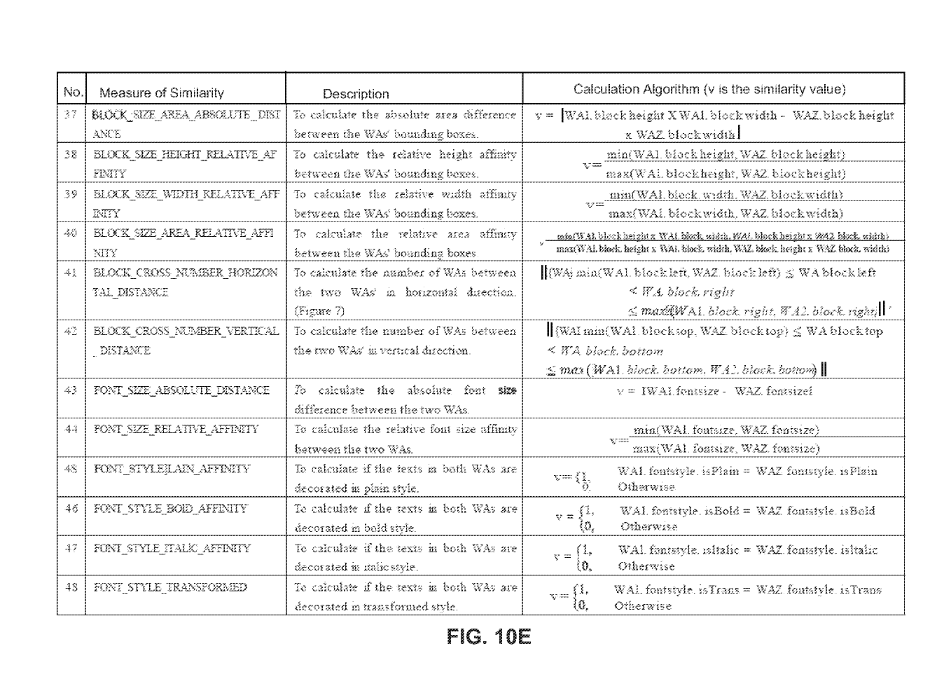

FIGS. 10A-10G depict a table of example measures of similarity;

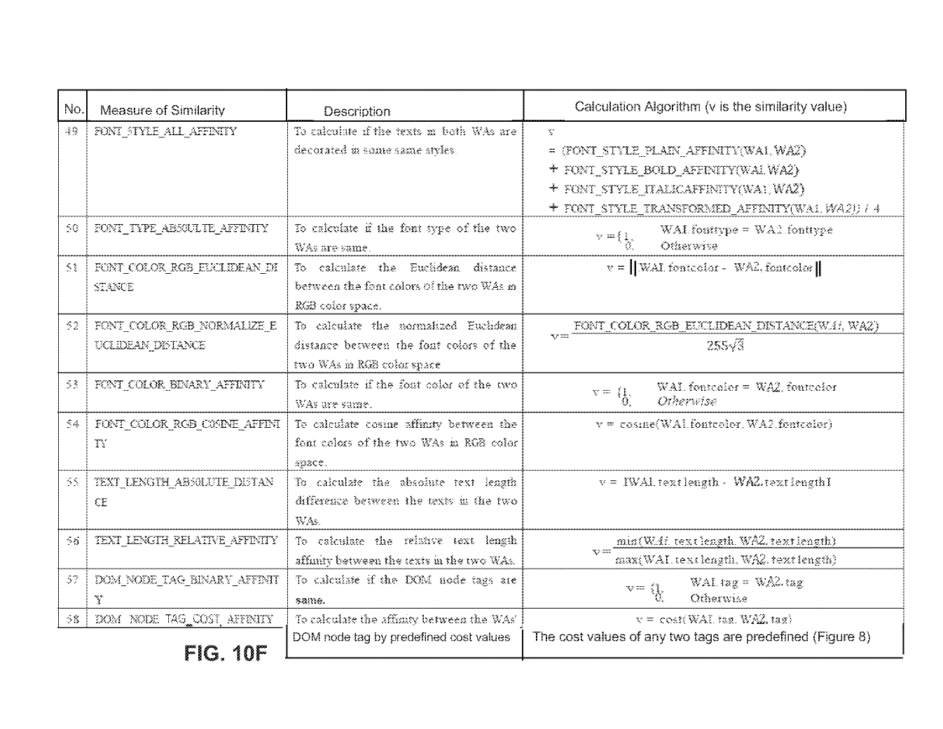

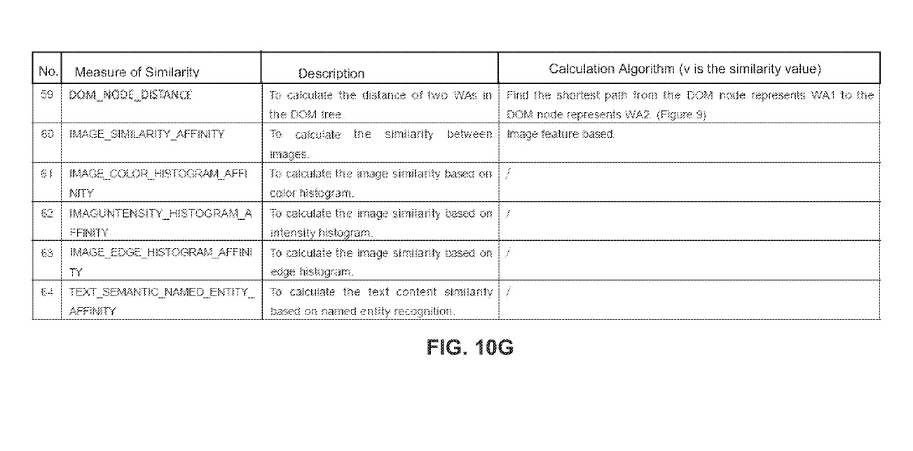

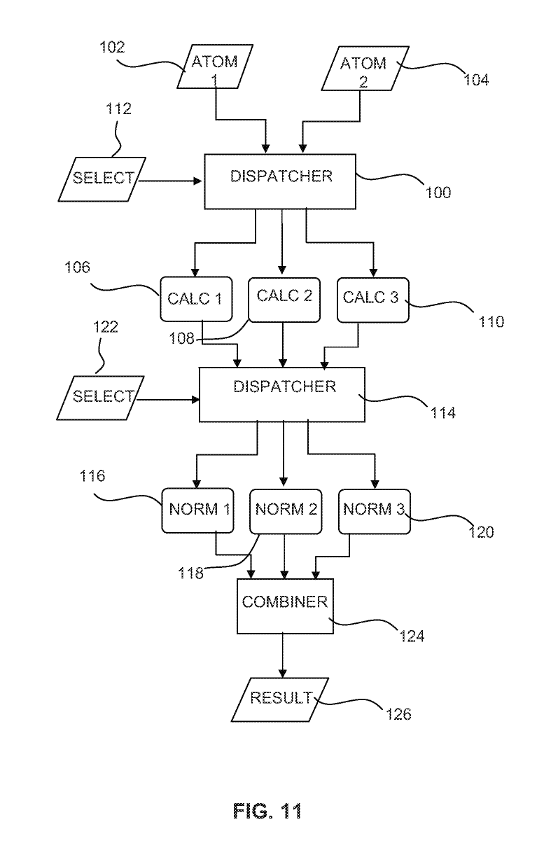

FIG. 11 depicts an example system for determining similarity between first and second elements of an electronic document;

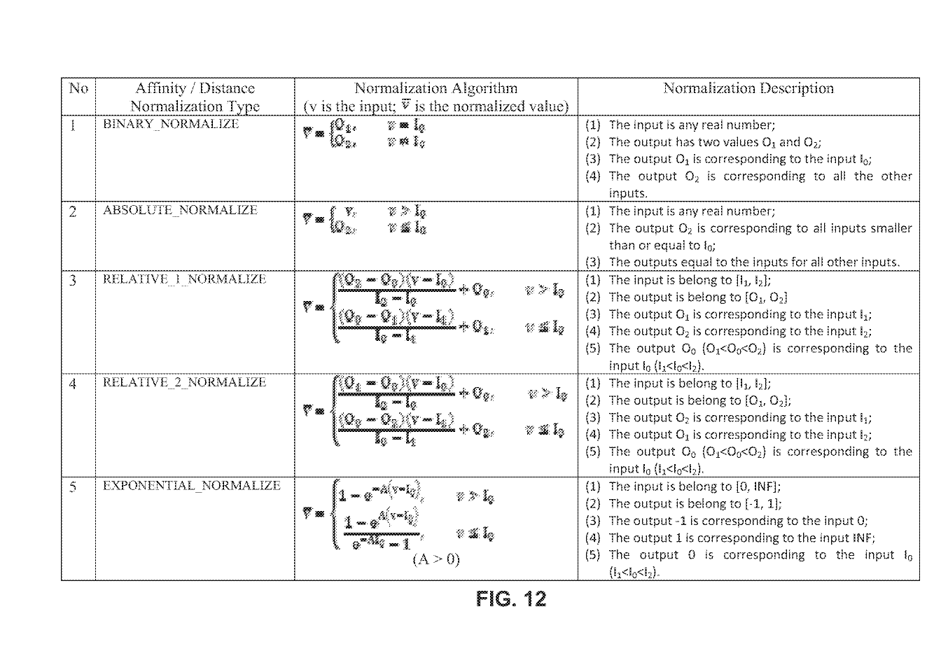

FIG. 12 depicts a table of example normalization algorithms;

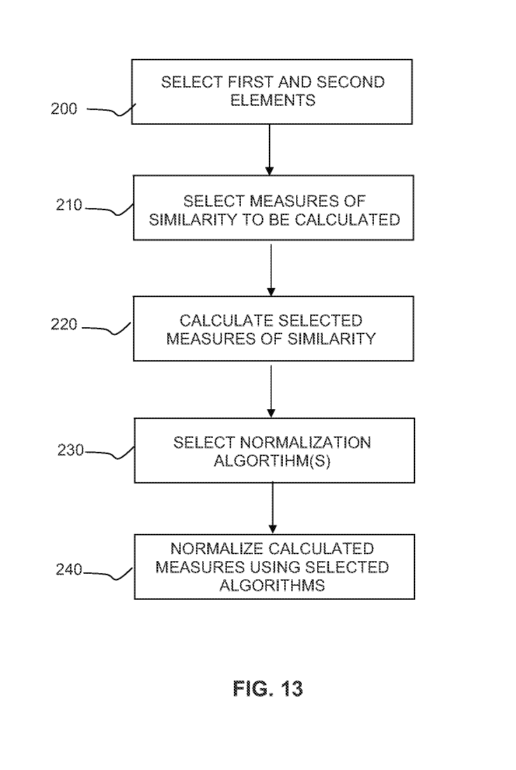

FIG. 13 depicts an example method of determining similarity between first and second elements of an electronic document; and

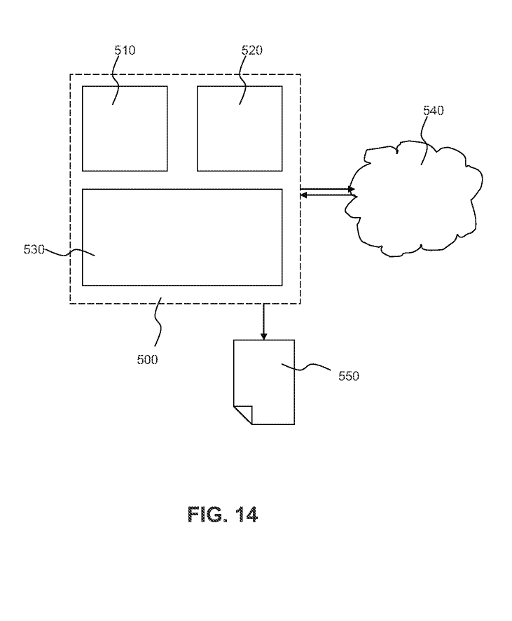

FIG. 14 schematically depicts a system for extracting information of interest from a web page.

### DETAILED DESCRIPTION

It should be understood that the Figures are merely schematic and are not drawn to scale. It should also be understood that the same reference numerals are used throughout the Figures to indicate the same or similar parts.

Methods of information retrieval use page segmentation or page structure analysis to divide an electronic document into elements or atoms which can then be compared for similarities. Similar elements can then be clustered and/or extracted according to information retrieval requirements.

However, determining a degree of similarity between elements may be problematic, especially when it involves determining the similarity of properties that are not easily comparable, for example.

There is provided an approach to determining similarity between elements of an electronic document by, firstly, calculating a plurality of different measures of similarity between the elements. The plurality of calculated measures of similarity may be combined to provide a single value representing the degree of similarity. The plurality of calculated measures of similarity may alternatively be used for decision making purposes, for example, without being combined into a single value. The measures of similarity may be calculated using different representations of the electronic document. A representation of an electronic document is a representation of the whole or part of the document in a particular form that may interpreted by a human or computer for example. Such representations may therefore include visual, DOM tree and semantic representations of the document, it content and/or its layout.

By way of example, where an electronic document is a web page, first to fourth representations of the web page may be a visual representation of the web page as it appears to a user of a web browser, a DOM tree representation of the content of the web page, a semantic representation of the web page content, and a markup language representation of the web page, respectively.

According to an embodiment, there is provided a computer-implemented method of determining similarity between first and second elements of an electronic document, comprising: using a computer, calculating a plurality of measures of similarity between the first and second elements in at least two representations of the electronic document.

Such a method may be used for extracting information from a target web page, wherein data of interest in a web page is selected and corresponding data is located by determining similarities in the web page data. Embodiments are therefore suitable for use in web page segmentation or web page structure analysis. In particular, determination of similarity between data elements may enable a segmentation algorithm to cluster coherent or similar atoms into blocks in an accurate manner.

In embodiments, a value representing the similarity between data elements is determined by calculating a plurality of different measures of similarity between the data elements.

By way of example, a first measure of similarity may be based on the difference between a first geometric property (such as location) of the first and second data elements in a model representation of the web page. A second measure of similarity may be based on the difference between a second, different geometric property (such as alignment) of the first and second data elements in a model representation of the web page. Alternatively, a measure of similarity may be based on the difference between a markup property (such as hyper-text markup language, HTML, tags) of the first and second data elements.

If the first and second data elements are represented by first and second nodes of a document object model, DOM, tree, respectively, an exemplary measure of similarity may be based on a degree of separation of the first and second nodes in the DOM tree.

Having calculated a plurality of different measures of similarity between the data elements, the different measures are combined to determine a single degree of similarity between the data elements. Alternatively, the different measures may used in conjunction with decision algorithms, for example, bypassing the requirement to combine the measures into a single value.

Examples of different measures of similarity will now be described with reference to FIGS. 1 through 9.

Referring to FIG. 1, a measure of similarity is based on the Euclidean distance D_{E} between the geometric locations of the two atoms, A1 and A2, in a visual representation of a web page. Here, the larger the distance D_{E} between the two atoms, the less similar the two atoms are. The Euclidean distance D_{E} between the atoms can thus be used as a direct measure of similarity in this example. Referring to FIG. 2, the block distance between the first A1 and second A2 atoms in a visual representation of a web page can be used as a measure of similarity, wherein the block distance D_{B1} is the sum of the horizontal Dx and vertical Dy offset distances between the two atoms A1 and A2. This may be represented by the equation D^{B1}=Dx+Dy. Alternatively, the block distance D_{B2} may be measured as the offset between the two atoms A1 and A2 in a single axis (as shown in FIG. 3 where the block distance D_{B2} is the horizontal offset between the two atoms A1 and A2.

Referring now to FIG. 4, whether the two atoms have (geometric) enclosure relation in a visual representation of a web page can be used as a measure of similarity. When an atom A2 is geometrically enclosed by another atom A1 (as illustrated in FIG. 4), the two atoms, A1 and A2, are likely to have a high degree of similarity.

Whether the two blocks intersect each other in a visual representation of a web page can also be used as a measure of similarity. As illustrated in FIG. 5, the amount by which a first atom A1 is overlapped or intersected by a second atom A2 is measured by the size of the overlapping area S. The size of the overlapping area S can therefore be used a direct measure of similarity between the first A1 and second A2 atoms.

Turning to FIGS. 6A to 6D, the horizontal and/or vertical alignment of two atoms in a visual representation of a web page can be used as a measure of similarity of the atoms. When first A1 and second A2 atoms are geometrically aligned, the two atoms, A1 and A2, are likely to have a high degree of similarity. Such geometrical alignment may be assessed with respect to a single axis or, alternatively, with respect to multiple axes. In FIGS. 6A to 60, various types of geometrical alignment of first A1 and second A2 atoms are illustrated with respect to the horizontal axis. FIG. 6A shows left-side alignment, FIG. 6B shows right-side alignment, FIG. 6C shows dual-sided alignment, and FIG. 6D shows no alignment with respect to the horizontal axis.

Referring to FIG. 7, another measure of similarity between first A1 and second A2 atoms can be computed based on how many other atoms are situated between the first A1 and second A2 atoms in a visual representation of a web page. Such a measure can be used to determine whether the first A1 and second A2 atoms are neighboring atoms. Two atoms, A1 and A2, are likely to have a high degree of similarity if they are neighbours, and the degree of similarity is likely to decrease as the number of other atoms between the first A1 and second A2 atom increases. In the example of FIG. 7. the number N of other atoms situated between the first A1 and second A2 atoms is two (i.e. N=2).

Unlike the measures of similarity that have been described above with reference to FIGS. 1-7, alternative measures of similarity may relate to properties of atoms in a different representation of the web page. Such alternative measures of similarity may be based on the difference between a markup property of two atoms.

For example, with reference to FIG. 8, a measure of similarity may be determined based on HTML tags attached to the atoms, wherein similarity values between different HTML tag types (e.g. <IMG>, <P>) are defined according to user requirements or design constraints for example.

Depending on the application, a user can create a table (as shown in FIG. 8b) which defines similarity values, S1 to S6, between different types of HTML tag. For example, in a text article extraction application, the similarity values can be defined in the table such that an image, IMG, tag and text-related tag, respectively, have a very low similarity value, and a node having an IMG tag is therefore unlikely to be determined to be similar to a node having a text-related tag.

Another measure of similarity may be based on the distance required to traverse between nodes of a DOM tree representation of an electronic document (such as a web page). FIG. 9 depicts a DOM tree 90 of a web page. The principle of creating a DOM tree representation for a web page is known to the skilled person so this will not be explained in further detail for the reason of brevity only.

In the example of FIG. 9, a measure of similarity between a first node N7 and a second node N5 is based on the distance D_{T} required to traverse from the first node N7 to the second node N5 in the DOM tree 90. Here, the traversal distance D_{T} between the first node N7 to the second node N5 may be represented by the equation D_{T}=d1+d3+d4+d5+d6, wherein d1 to d8 each define the distance between two nodes as illustrated in FIG. 9. The larger the traversal distance D_{T} between the two atoms, the less similar the two atoms are. The traversal distance D_{T} between the atoms can thus be used a direct measure of similarity. Such computation of the distance of DOM tree traversal exploits the structure of a DOM tree.

Note that, although FIGS. 1-7 illustrate how geometric information may be used to determine a measure of similarity between atoms, FIG. 8 shows how markup tag information may be used, and FIG. 9 shows how a DOM structure may be used, alternative examples may make use of a data element's font size, style, color, type, etc.

By way of demonstrating the various different measures of similarity that may be calculated, the table depicted in FIG. 10 details many examples that may be employed.

Having calculated a plurality of different measures of similarity between data elements, the different measures may be combined to determine a single value representing a degree of similarity between data elements. If the different measures are all numerical in value, they may be combined through simple addition and/or subtraction to provide a single numerical value representing a degree of similarity. Other more complex algorithms for combining the different measures of similarity may be used which take account of their relative importance, for example. The different measures of similarity may also be normalized prior to being combined.

FIG. 11 depicts a system according to an embodiment. An input dispatcher 100 is adapted to receive first 102 and second 104 data elements as inputs and to output both of the first and second data elements to first 106, second 108, and third 110 similarity calculating units based on a user input 112 provided to the input dispatching unit 100.

The user input 112 defines the different measures of similarity that are to be calculated. For example, in the example of FIG. 11 the user input 112 selects three different measures of similarity from those listed in the table of FIG. 10. Depending on the measures of similarity selected, both of the input data elements 102 and 104 for comparison are sent to the first 106 to third 110 calculation units, each of which is adapted to calculate one of the selected measures of similarity.

The first 106 to third 110 calculation units each calculate a different one of the three selected measures of similarity and output the respective calculation result to a result dispatching unit 114. The result dispatching unit 114 receives the three calculation results as inputs and outputs the calculation results to first 116, second 118, and third 120 normalization units based on a second user input 122 provided to the result dispatching unit 114.

Similarly to the user input 112 provided to the input dispatching unit, the second user input 122 defines the different normalization methods that are to be employed.

To demonstrate the various different normalization methods that may be selected, the table depicted in FIG. 12 details many examples of normalization methods. In the example of FIG. 11, the second user input 122 selects three different normalization methods from those listed in the table of FIG. 12. Depending on the normalization methods selected, the calculation results are sent to the first 116 to third 120 normalization units, each of which is adapted to perform one of the selected normalization methods (for example, normalize a calculated similarity value to a specified interval such as zero to one, [0,1]). The first 116 to third 120 normalization units each output a respective normalization result to a result combining unit 124. The result combining unit 124 receives the normalization results as inputs and combines the normalization inputs to determine a single output value 126 representing a degree of similarity between the first 102 and second 104 data elements. Since the inputs provided to the combining unit 124 have been normalized, the inputs can be combined in a simple manner, such as adding the results together (using a simple or weighted sum, for example) to obtain a single output value 126.

Here, the system has separate similarity calculation units and separate normalization units. Alternative examples may combine these units so that a single processing unit undertakes the calculation of the different measures of similarity and the normalization algorithms.

A flow diagram of an example method is shown in FIG. 13. In the first step 200, the first and second elements of an electronic document to be compared are selected (by a user or automatically according to programmed instructions, for example). Next, in step 210, a plurality of different measures of similarity is selected according to predetermined requirements. For example, the different measures may be selected from those listed in the table of FIG. 10, wherein at least two of the measures are calculated using different representations of the electronic document.

The method then continues to step 220 in which the selected measures of similarity between the first and second data elements are calculated. Here, the processing means used to undertake such calculation may depend on the selected measures of similarity. Thus, the data elements may be provided to one or more processing units depending on their available processing capabilities.

Next, in step 230, a plurality of different normalization algorithms are selected according to predetermined requirements. For example, the different normalization algorithms may be selected from those listed in the table of FIG. 12, and the selected algorithms may depend on the measures of similarity that have been calculated.

In step 240, the measures of similarity calculated in step 220 are normalized using the algorithms selected in step 230. The processing means used to complete the normalization algorithms may or may not be the same as those used to calculate the measures of similarity in step 22. Thus, as before, the calculated measures of similarity may be provided to one or more processing units.

Embodiments may be captured in a computer program product for execution on the processor of a computer, e.g. a personal computer or a network server, where the computer program product, if executed on the computer, causes the computer to implement the steps of the method, e.g. the steps as shown in FIG. 10. Since implementation of these steps into a computer program product requires routine skill only for a skilled person, such an implementation will not be discussed in further detail for reasons of brevity only.

In an embodiment, the computer program product is stored on a computer-readable medium. Any suitable computer-readable medium, e.g. a CD-ROM, DVD, USB stick, Internet-accessible data repository, and so on, may be considered.

In an embodiment, the computer program product may be included in a system for extraction of information of interest from a web page, such as a system 500 shown in FIG. 14. The system 500 comprises a user annotation module 510, which allows a user to tell the system 500 the type of information he wants the system 500 to monitor and extract. The information selection may be achieved e.g. by pointing a mouse (not shown) at an item of interest, e.g. a text passage or image, on a source web page, tagging the item of interest. The system 500 is configured to generate and store corresponding extraction rules for extracting corresponding information from target web pages.

The system 500 further comprises a web page download/crawling module 520, which is another user interface. The user annotation module 510 is responsible for collecting the information of interest to the user, whereas the web page download/crawling module 520 is responsible for collecting the target web page(s) from which user the wants to extract information, and for downloading the webpages from the Internet 540 for post-processing.

In an embodiment, the user annotation module 510 and the web page download/crawling module 520 may be combined into a single module, or may be distributed over two or modules.

The system 500 further comprises an information extraction module 540, which comprises the part of the aforementioned computer program product that is responsible for the determining the similarity between elements of the webpage(s) and the subsequent extraction of information having a degree of similarity exceeding a predetermined threshold value. The system 500 further comprises a result aggregation module 530 for aggregating the extracted information and presenting this information to the user or subsequent applications in any suitable form, e.g. digitally or in text form, e.g. on a computer screen or as a print-out 550.

Typically, in a DOM tree, information of interest to a user will reside in a leaf node, e.g. a text or image node. For this reason, although examples have been described in relation to leaf nodes, it should be understood that the inventive algorithm is equally applicable for information in intermediate nodes, i.e. nodes in a path between the root node and a leaf node.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. A computer-implemented method of determining similarity between first and second elements of an electronic document, comprising:
using a computer, calculating a plurality of measures of similarity between the first and second elements in at least two representations of the electronic document.

2. The method of claim 1, wherein each of the at least two representations comprise at least one of: a visual representation; a document object model, DOM, tree; a semantic representation; and a markup language representation.

3. The method of claim 1, further comprising the step of:
using a computer, normalizing the plurality of calculated measures of similarity.

4. The method of claim 1, further comprising the step of:
using a computer, combining the plurality of calculated measures to determine a value representing a degree of similarity between the first and second elements.

5. The method of claim 1, wherein at least one of the representations of the electronic document is a DOM tree, and wherein at least one of the plurality of measures of similarity is calculated based on a degree of separation of the first and second elements in the DOM tree.

6. The method of claim 1, wherein at least one of the representations of the electronic document is a visual representation of the electronic document, and wherein at least one the plurality of measures of similarity is calculated based on the difference between a geometric property of the first and second elements in the visual representation.

7. The method of claim 1, wherein the electronic document is a web page, and wherein at least one of the plurality of measures of similarity is calculated based on the difference between a markup language property of the first and second data elements.

8. The method of claim 1, wherein the first and second elements comprise text data, and wherein at least one of the plurality of measures of similarity is calculated based on the difference between a font property of the first and second data elements.

9. The method of claim 1, wherein the first and second elements comprise image data, and wherein at least one of the plurality of measures of similarity is calculated based on the difference between an image property of the first and second data elements.

10. A computer-implemented method of automatically extracting data from an electronic document, comprising;
using a computer, generating at least two representations of the electronic document;
using a computer, selecting first and second elements of the electronic document;
using a computer, determining similarity between the first and second elements according to claim 1;
using a computer, extracting data from the second element based on the plurality of calculated measures of similarity.

11. The method of claim 10, wherein the step of extracting data comprises the steps of:
combining the plurality of calculated measures to determine a value representing a degree of similarity between the first and second elements; and
extracting data from the selected element if the determined degree of similarity exceeds a predetermined threshold.

12. The method of claim 10, further comprising presenting the extracted data to a user.

13. A computer program product comprising computer program code adapted, when executed on a computer, to cause the computer to implement the steps of:
calculating a plurality of measures of similarity between the first and second elements in at least two representations of the electronic document.

14. A computer-readable medium having computer-executable instructions stored thereon that, if executed by a computer, cause the computer to implement the steps of:
calculating a plurality of measures of similarity between the first and second elements in at least two representations of the electronic document.

15. A system comprising a computer and the computer program product of claim 13.
